(19) United States
(12) Patent Application Publication
(10) Pub. No.: US 2009/0225230 A1
(43) Pub. Date: Sep. 10, 2009

(54) Method and apparatus for power management for mobile devices

(76) Inventors: Bernal Antonio Arroyo, San Jose, CA (US); Thomas James Woch, Las Altos, CA (US)

Correspondence Address: Thomson Licensing LLC, P.O. Box 5312, Two Independence Way, PRINCETON, NJ, 08543-5312, US

(21) Appl. No.: 11/990,664

(22) PCT Filed: Aug. 22, 2006
(86) PCT No.: PCT/US06/32943

§ 371 Date: Feb. 19, 2008

Related U.S. Application Data
(60) Provisional application No. 60/710,735, filed on Aug. 24, 2005.

(51) Int. Cl. H04N 5/63

(52) U.S. Cl. 348/730; 348/E05.127

(57) ABSTRACT

There are provided a method and apparatus for power management in a mobile device. The apparatus includes a mode detector and a power manager. The mode detector is for detecting a current operating mode of the mobile device. The power manager (120) is for managing a power consumption of the mobile device based on the detected current operating mode. The power manager activates or deactivates at least one digital television function of the mobile device to manage the power consumption of the mobile device.

### CROSS-REFERENCE TO RELATED APPLICATIONS

This application claims the benefit of U.S. Provisional Application Ser. No. 60/710,735 filed Aug. 24, 2005, which is incorporated by reference herein in its entirety.

### TECHNICAL FIELD

The present principles relate generally to mobile devices and, more particularly, to a method and apparatus for power management for mobile devices.

### BACKGROUND

Mobile devices are subject to limitations based on limited battery power. That is, the usefulness of mobile devices is limited due to limited available battery power. For example, a mobile television for receiving digital terrestrial signals may be powered by an external power source or a battery. When operated from a battery, such a device is highly sensitive to power consumption.

### SUMMARY

These and other drawbacks and disadvantages of the prior art are addressed by the present principles, which are directed to a method and apparatus for power management for mobile devices.

According to an aspect of the present principles, there is provided an apparatus for power management in a mobile device. The apparatus includes a mode detector and a power manager. The mode detector is for detecting a current operating mode of the mobile device. The power manager is for managing a power consumption of the mobile device based on the detected current operating mode. The power manager activates or deactivates at least one digital television function of the mobile device to manage the power consumption of the mobile device.

According to another aspect of the present principles, there is provided a method for power management in a mobile device. The method includes detecting a current operating mode of the mobile device. The method further includes managing a power consumption of the mobile device based on the detected current operating mode. The managing step activates or deactivates at least one digital television function of the mobile device to manage the power consumption of the mobile device.

These and other aspects, features and advantages of the present principles will become apparent from the following detailed description of exemplary embodiments, which is to be read in connection with the accompanying drawings.

### BRIEF DESCRIPTION OF THE DRAWINGS

The present principles may be better understood in accordance with the following exemplary figures, in which:

FIG. 1 is a block diagram of an exemplary apparatus for power management for a mobile device in accordance with an embodiment of the present principles;

FIG. 2 is a flow diagram of an exemplary method for power management in a mobile device in accordance with an embodiment of the present principles; and

FIG. 3 is a high-level block diagram of power consumption states of a mobile device in accordance with an embodiment of the present principles.

### DETAILED DESCRIPTION

The present principles are directed to a method and apparatus for power management for mobile devices.

The present description illustrates the present principles. It will thus be appreciated that those skilled in the art will be able to devise various arrangements that, although not explicitly described or shown herein, embody the present principles and are included within its spirit and scope.

All examples and conditional language recited herein are intended for pedagogical purposes to aid the reader in understanding the present principles and the concepts contributed by the inventor(s) to furthering the art, and are to be construed as being without limitation to such specifically recited examples and conditions.

Moreover, all statements herein reciting principles, aspects, and embodiments of the present principles, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the present principles. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read-only memory (“ROM”) for storing software, random access memory (“RAM”), and non-volatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The present principles as defined by such claims reside in the fact that the functionalities provided by the various recited means are combined and brought together in the manner which the claims call for. It is thus regarded that any means that can provide those functionalities are equivalent to those shown herein.

Reference in the specification to “one embodiment” or “an embodiment” of the present principles means that a particular feature, structure, characteristic, and so forth described in connection with the embodiment is included in at least one embodiment of the present principles. Thus, the appearances of the phrase “in one embodiment” or “in an embodiment” appearing in various places throughout the specification are not necessarily all referring to the same embodiment.

As noted above, the present principles are directed to a method and apparatus for power management for mobile devices. Advantageously, the present principles allow for the management of the overall power consumption of a mobile device so as to make it possible for the user to obtain maximum use from battery operation.

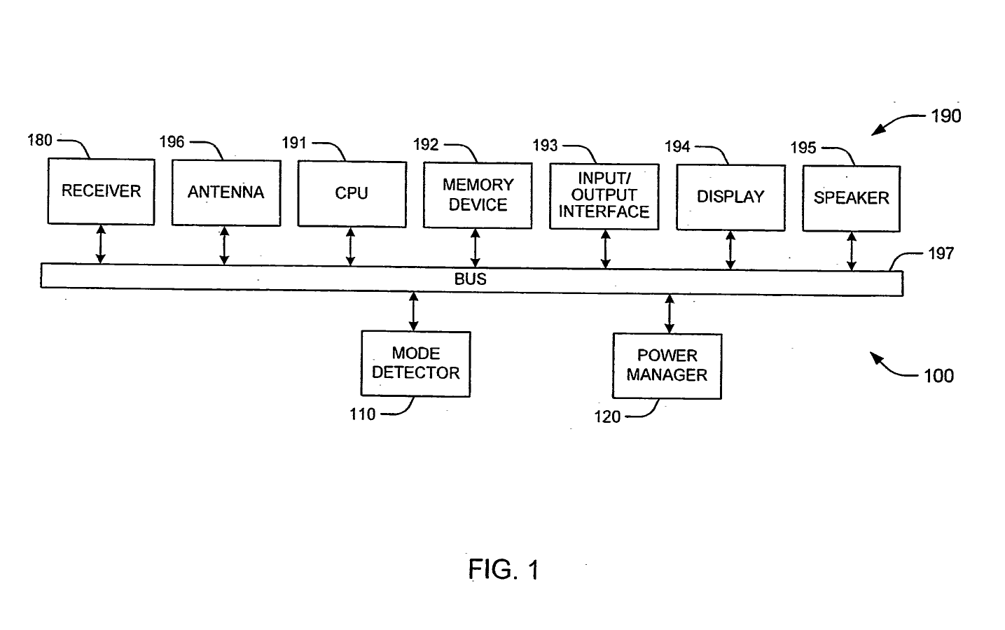

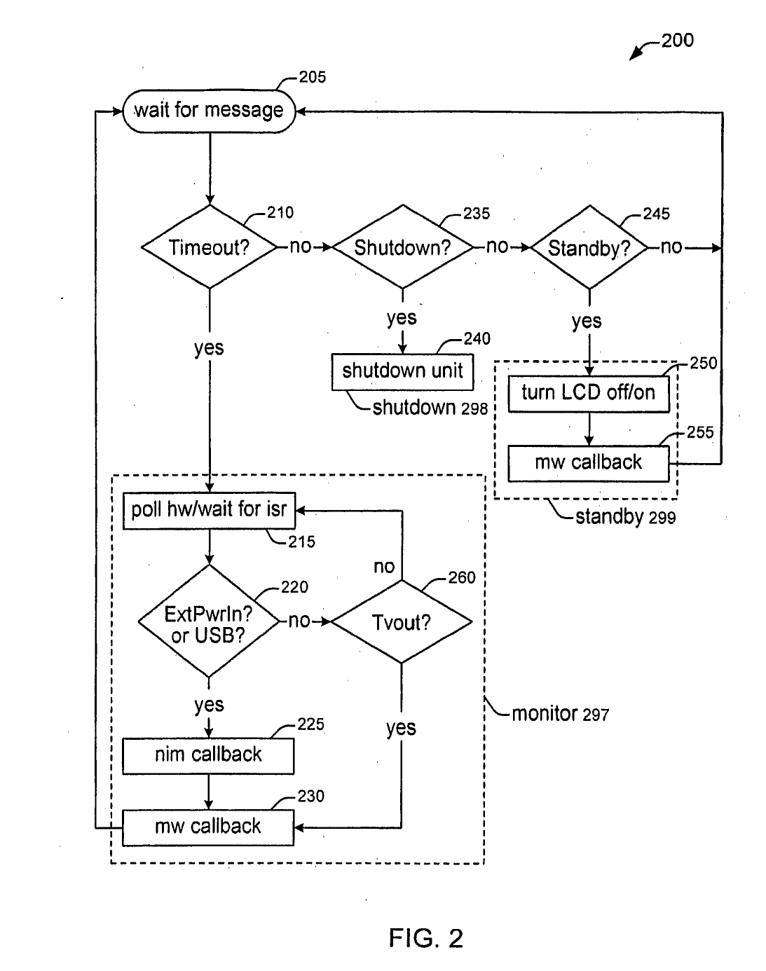

Turning to FIG. 1, an exemplary apparatus for power management for a mobile device is indicated generally by the reference numeral 100.

The apparatus 100 is incorporated into a mobile device 190. For the sake of brevity, a brief description of the mobile device 190 is provided. However, one of ordinary skill in this and related arts will contemplate the following and other elements and implementations of a mobile device to which the present principles may be applied, while maintaining the scope of the present principles. The mobile device 190 includes a processor 191, at least one memory device 192, an input/output interface 193, a display 194, at least one speaker 195, at least one receiver 180, and an antenna 196. Bus 197 interconnects the preceding elements of the mobile device 190.

The processor 191 may be, e.g., a digital signal processor, or may include a digital signal processing portion, for processing digital signals such as audio and video signals. Accordingly, any of the processor 191 and one or more of the at least one receiver 180 may include corresponding elements or circuitry for performing signal processing including, but not limited to, signal reception, demodulation, and so forth. Such elements and circuitry may include, e.g., digital-to-analog converters (DACs), tuners, and so forth.

The apparatus 100 includes a mode detector 110 and a power manager 120 (hereinafter also collectively referred to herein as “power manager”). Bus 197 also interconnects the preceding elements of the apparatus 100, as well as connecting the elements of the apparatus 100 to the elements of the mobile device 190. Of course, given the teachings of the present principles provided herein, one of ordinary skill in this and related arts will contemplate these and various other elements in an apparatus for power management for a mobile device, while maintaining the scope of the present principles.

The mode detector 110 detects different operating modes of the mobile device 190. Accordingly, the mode detector 110 is capable of providing an indication of a current operating mode of the mobile device 190. The power manager 120 is capable of collecting information from other elements (including the mode detector 110 as well as other elements of the mobile device 190 itself), passing information to other elements, and taking action based on information from other elements and/or on its own. The outcome of this action will be to change the power consumption of one or more elements so that their contribution to the overall power consumption is minimized.

It is to be appreciated that while the mode detector 110 and the power manager 120 are shown as separate elements from those described as part of the mobile device 190, one of ordinary skill in this and related arts can appreciate that one or more existing components of the mobile device 190 may also be used to implement an apparatus for power management for a mobile device in accordance with the present principles while maintaining the scope of the present principles. For example, the apparatus 100 may use one or more existing elements of the mobile device 190 to implement the present principles. Such existing devices may include, but are not limited to, the processor 191 and the at least one memory device 192.

In an embodiment, the present principles are applied to manage the power consumption of a mobile digital television that receives digital terrestrial signals. The mobile digital television is capable of being powered by an external power source or a battery. Advantageously, the present principles allow for the maximization of the time that the mobile digital television can operate on battery power while providing an acceptable video viewing experience. In an embodiment, different operating modes of the mobile device are detected and power consumption of the mobile device is tailored accordingly to maximize battery life.

Based on the different modes of operation of the mobile device, the mobile device can be in one of a number of states each one having its own power consumption profile. A power state is well defined in the sense that the power consumption of the hardware components in that state is well defined. An embodiment of the present principles will transition the mobile device through the different power states by managing the power of elements (e.g., hardware elements) of the mobile device.

Information on system and element(s) conditions is collected periodically. When the status of the system and/or an element(s) changes, a message is sent and the appropriate course of action taken based on the message. In an embodiment, the following hardware information may be monitored in accordance with the present principles: whether USB is attached; whether external power is applied to the unit; the battery state and charge level; and whether the TV out connection is made. Of course, given the teachings of the present principles provided herein, one of ordinary skill in this and related arts will contemplate these and various other types of information that may be monitored for the purpose of power management, while maintaining the scope of the present principles.

In an embodiment, the present principles implement power management in the mobile device using a series of interrupt service routines (ISRs) and a task.

The task waits for messages indicating a change in hardware conditions. These messages can come either from ISRs or from data collected by the task on a periodic basis. Certain hardware changes may not necessarily generate and interrupt, hence, the hardware elements that generate these changes are polled periodically for status. When an ISR comes in or polling reveals a change in conditions, the power manager takes appropriate action. While this action depends on the type of change, it is typically geared to minimizing power consumption.

In an embodiment, the power manager puts the unit in standby mode upon input from the user. In standby mode, the power manager may carry out several actions to minimize power consumption. Among these action is turning off the Liquid Crystal Display (LCD) or other type of display and the powering down of the audio and video digital-to-analog converters (DACs) within the main microprocessor. If the mobile device has remained in standby mode for at least 15 minutes and it is operating from the battery, the power manager will shut down the mobile device to save battery power. Another function of the power manager is to notify the front-end and subsystems about changes in element (e.g., hardware) status. The front-end subsystem is notified whether external power is applied or removed. This enables the front-end subsystem to manage the power consumption of its receivers.

Turning to FIG. 2, an exemplary method for power management in a mobile device is indicated generally by the reference numeral 200. The method 200 includes a start/wait for message block 205 that passes control to a decision block 210. The decision block 210 determines whether or not a timeout condition has occurred. If so, then control is passed to a function block 215. Otherwise, control is passed to a decision block 235.

The function block 215 polls the hardware, waits for an ISR, and passes control to a decision block 220. The decision block 220 determines whether or not an external power source is being used and/or whether a USB device is attached. If so, then control is passed to a function block 225. Otherwise, control is passed to a decision block 260.

The function block 225 sends a message indicating a change in state, and passes control to a function block 230. Regarding the function block 225, such block may be implemented as a software mechanism that sends a message to another layer (e.g., a software layer such as a receiver block) regarding the state change (hardware configuration change, e.g., USB was plugged in, external power was plugged in, and so forth). The function block 230 sends a message indicating the change in state, and returns control to the start/wait for message block 205. Regarding function block 230, such block may be implemented as a software mechanism that sends a message to another layer (e.g., middleware) regarding the state change.

The decision block 260 determines whether or not a TV out connection is made. If so, then control is passed to the function block 230. Otherwise, control is returned to the function block 215.

The decision block 235 determines whether or not a shutdown input has been received. If so, then control is passed to a function block 240. Otherwise, control is passed to a decision block 245.

The function block 240 shuts down the mobile device, and the method is terminated.

The decision block 245 determines whether or not a standby mode input has been received. If so, then control is passed to a function block 250. Otherwise, control is returned to function block 205.

The function block 250 turns off/on the LCD screen, and passes control to a function block 255. The function block 255 sends a message to another layer indicating a change in state, and returns control to the start/wait for message block 205. Regarding function block 250, such block may be implemented as a software mechanism that sends a message to another layer (e.g., middleware) regarding the state change.

It is to be appreciated that blocks 215, 220, 225, 230, and 260 correspond to a monitor state 297. Moreover, the function block 240 corresponds to a shutdown state 298. Also, the function blocks 250 and 255 correspond to a standby state 299.

It is to be further appreciated that while some of the blocks of the method 200 of FIG. 2 have been described with respect to a particular implementation of hardware, software, and so forth, the present principles are not so limited and, thus, given the teachings of the present principles provided herein, other implementations may also be used while maintaining the scope of the present principles.

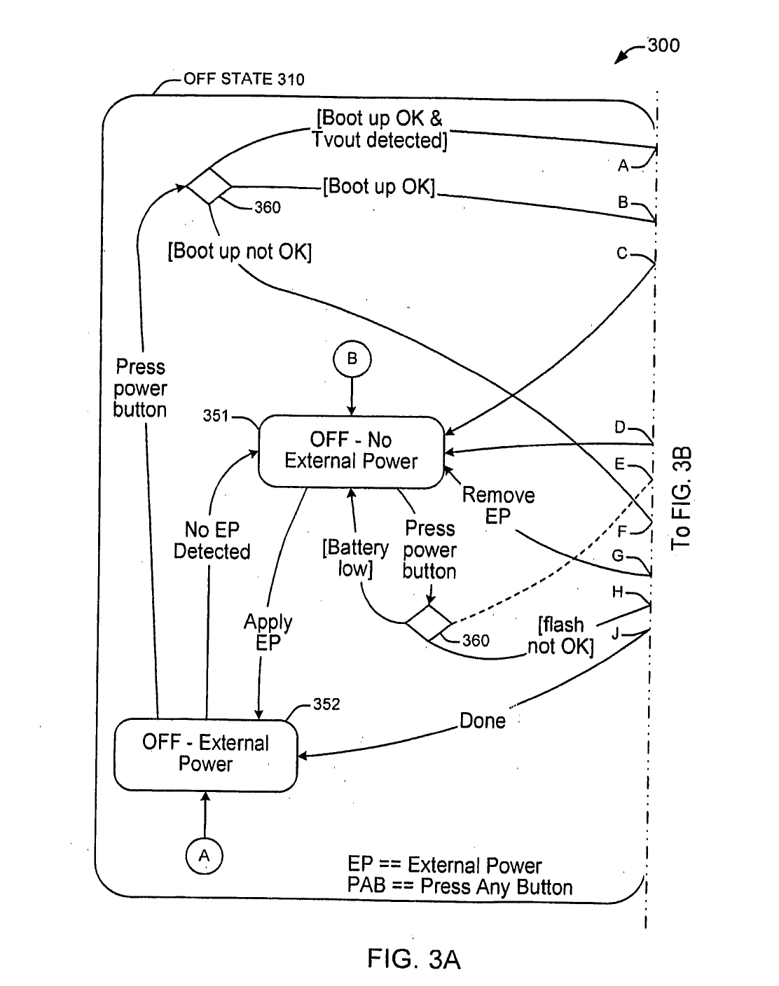

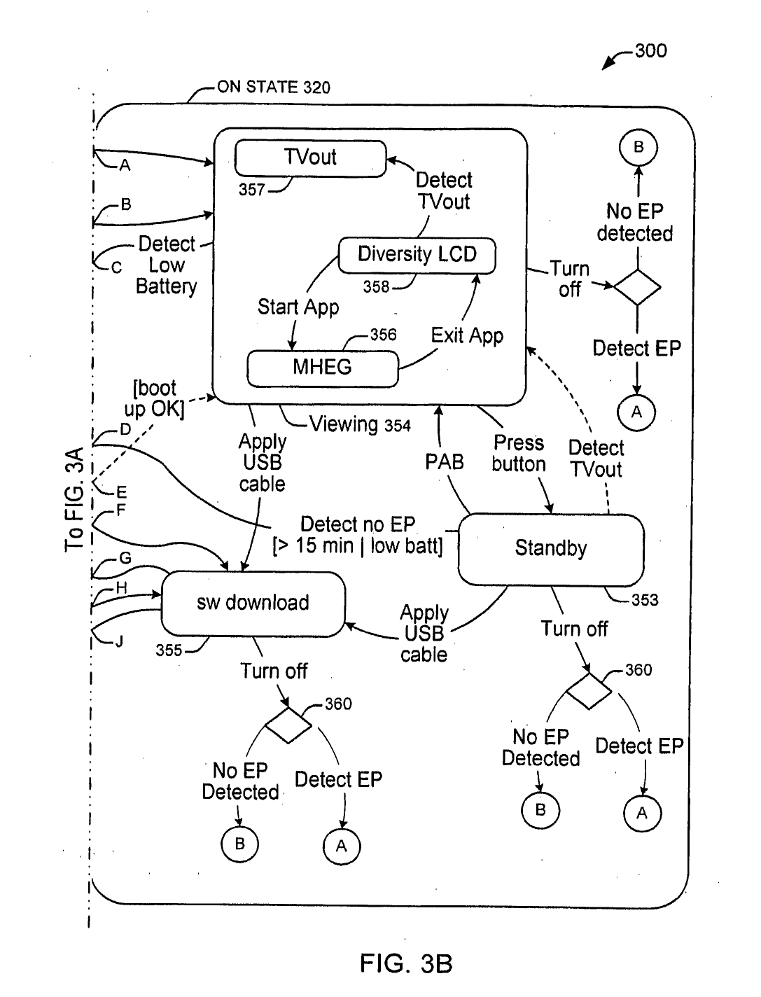

Turning to FIG. 3, exemplary power consumption states of a mobile device are indicated generally by the reference numeral 300. The power consumption states 300 include an off state 310 and an on state 320.

Many of the situations shown in FIG. 3 relate to external power (EP) being applied or not to the mobile device 351, 352, as well as a current mode (e.g., standby 353, boot up) of the mobile device, viewing 354, current applications (e.g., downloading software 355, running a Multimedia and Hypermedia information coding Expert Group (MHEG) application 356), having an active TV out connection 357, use of diversity mode 358 (i.e., the use of two receivers to receive the same signal or a different signal and optional use of PIP or similar technology in the latter case to simultaneously display both signals), connection of a USB device, and a low battery condition. In some cases, a press any button (PAB) input or the pressing of a power button may be used to switch modes, and so forth. Decision diamonds 360 illustrate the control flow for two or more possible paths.

A description will now be given of some of the many attendant advantages/features of the present invention, some of which have been mentioned above. For example, one advantage/feature is an apparatus for power management in a mobile device. The apparatus includes a mode detector for detecting a current operating mode of the mobile device. The apparatus further includes a power manager for managing a power consumption of the mobile device based on the detected current operating mode. The power manager activates or deactivates at least one digital television function of the mobile device to manage the power consumption of the mobile device.

Another advantage/feature is the apparatus as described above, wherein the mode detector detects the current operating mode of the mobile device based on one or more hardware states relating to hardware of the mobile device.

Yet another advantage/feature is the apparatus having the mode detector that detects the current operating mode of the mobile device based on one or more hardware states as described above, wherein the mode detector determines the hardware states using at least one of interrupts and polling.

Further, another advantage/feature is the apparatus having the mode detector that detects the current operating mode of the mobile device based on one or more hardware states as described above, wherein the mode detector polls the hardware of the mobile device to obtain data used to detect the current operating mode of the mobile device.

Moreover, another advantage/feature is the apparatus having the mode detector that detects the current operating mode of the mobile device based on one or more hardware states as described above, wherein the hardware states include at least one of whether a universal serial bus device is attached to the mobile device, a current charge level of a battery powering the mobile device, whether an external power source is applied to the mobile device, and whether a television out connection is currently active.

Also, another advantage/feature is the apparatus having the mode detector that detects the current operating mode of the mobile device based on one or more hardware states as described above, wherein the mobile device includes at least one front end sub-system and at least one middleware sub-system, and the power manager notifies at least one of the at least one front end sub-system and the at least one middleware sub-system of any changes to a pre-specified group of the hardware states relating to a pre-specified group of the hardware elements.

Additionally, another advantage/feature is the apparatus as described above, wherein the power manager activates or deactivates hardware supporting the at least one digital television function to manage the power consumption of the mobile device.

Moreover, another advantage/feature is the apparatus as described above, wherein the at least one digital television function relates to at least one of a diversity mode function, a display function, and a digital-to-analog (DAC) conversion function.

Further, another advantage/feature is the apparatus as described above, wherein the power manager manages the power consumption of the mobile device by selecting from among a plurality of different power consumption profiles.

Also, another advantage/feature is the apparatus as described above, wherein the power manager activates or deactivates various hardware of the mobile device in accordance with the selected power consumption profile.

These and other features and advantages of the present principles may be readily ascertained by one of ordinary skill in the pertinent art based on the teachings herein. It is to be understood that the teachings of the present principles may be implemented in various forms of hardware, software, firmware, special purpose processors, or combinations thereof.

Most preferably, the teachings of the present principles are implemented as a combination of hardware and software. Moreover, the software may be implemented as an application program tangibly embodied on a program storage unit. The application program may be uploaded to, and executed by, a machine comprising any suitable architecture. Preferably, the machine is implemented on a computer platform having hardware such as one or more central processing units (“CPU”), a random access memory (“RAM”), and input/output (“I/O”) interfaces. The computer platform may also include an operating system and microinstruction code. The various processes and functions described herein may be either part of the microinstruction code or part of the application program, or any combination thereof, which may be executed by a CPU. In addition, various other peripheral units may be connected to the computer platform such as an additional data storage unit and a printing unit.

It is to be further understood that, because some of the constituent system components and methods depicted in the accompanying drawings are preferably implemented in software, the actual connections between the system components or the process function blocks may differ depending upon the manner in which the present principles are programmed. Given the teachings herein, one of ordinary skill in the pertinent art will be able to contemplate these and similar implementations or configurations of the present principles.

Although the illustrative embodiments have been described herein with reference to the accompanying drawings, it is to be understood that the present principles is not limited to those precise embodiments, and that various changes and modifications may be effected therein by one of ordinary skill in the pertinent art without departing from the scope or spirit of the present principles. All such changes and modifications are intended to be included within the scope of the present principles as set forth in the appended claims.

1. An apparatus for power management in a mobile device, comprising:
a mode detector for detecting a current operating mode of the mobile device; and
a power manager for managing a power consumption of the mobile device based on the detected current operating mode,
wherein the power manager activates or deactivates at least one digital television function of the mobile device to manage the power consumption of the mobile device.

2. The apparatus of claim 1, wherein said mode detector detects the current operating mode of the mobile device based on one or more hardware states relating to hardware of the mobile device.

3. The apparatus of claim 2, wherein said mode detector determines the hardware states using at least one of interrupts and polling.

4. The apparatus of claim 2, wherein said mode detector polls the hardware of the mobile device to obtain data used to detect the current operating mode of the mobile device.

5. The apparatus of claim 2, wherein the hardware states include at least one of whether a universal serial bus device is attached to the mobile device, a current charge level of a battery powering the mobile device, whether an external power source is applied to the mobile device, and whether a television out connection is currently active.

6. The apparatus of claim 2, wherein said mobile device includes at least one front end sub-system and at least one middleware sub-system, and said power manager notifies at least one of the at least one front end sub-system and the at least one middleware sub-system of any changes to a pre-specified group of the hardware states relating to a pre-specified group of the hardware elements.

7. The apparatus of claim 1, wherein said power manager activates or deactivates hardware supporting the at least one digital television function to manage the power consumption of the mobile device.

8. The apparatus of claim 1, wherein said at least one digital television function relates to at least one of a diversity mode function, a display function, and a digital-to-analog (DAC) conversion function.

9. The apparatus of claim 1, wherein said power manager manages the power consumption of the mobile device by selecting from among a plurality of different power consumption profiles.

10. The apparatus of claim 1, wherein said power manager activates or deactivates various hardware of the mobile device in accordance with the selected power consumption profile.

11. A method for power management in a mobile device, comprising:
detecting a current operating mode of the mobile device; and
managing a power consumption of the mobile device based on the detected current operating mode,
wherein said managing step activates or deactivates at least one digital television function of the mobile device to manage the power consumption of the mobile device.

12. The method of claim 11, wherein said detecting step detects the current operating mode of the mobile device based on one or more hardware states relating to hardware of the mobile device.

13. The method of claim 12, wherein said detecting step determines the hardware states using at least one of interrupts and polling.

14. The method of claim 12, wherein said detecting step polls the hardware of the mobile device to obtain data used to detect the current operating mode of the mobile device.

15. The method of claim 12, wherein the hardware states include at least one of whether a universal serial bus device is attached to the mobile device, a current charge level of a battery powering the mobile device, whether an external power source is applied to the mobile device, and whether a television out connection is currently active.

16. The method of claim 12, wherein said mobile device includes at least one front end sub-system and at least one middleware sub-system, and the method further comprises notifying at least one of the at least one front end sub-system and the at least one middleware sub-system of any changes to a pre-specified group of the hardware states relating to a pre-specified group of the hardware elements.

17. The method of claim 11, wherein said managing step activates or deactivates hardware supporting the at least one digital television function to manage the power consumption of the mobile device.

18. The method of claim 11, wherein said at least one digital television function relates to at least one of a diversity mode function, a display function, and a digital-to-analog (DAC) conversion function.

19. The method of claim 11, wherein said managing step manages the power consumption of the mobile device by selecting from among a plurality of different power consumption profiles.

20. The method of claim 11, wherein said managing step activates or deactivates various hardware of the mobile device in accordance with the selected power consumption profile.
